(19) United States
(12) Patent Application Publication
(10) Pub. No.: US 2010/0027571 A1
(43) Pub. Date: Feb. 4, 2010

(54) Stabilized near-infrared laser

(76) Inventor: Keith M. Murdoch, San Jose, CA (US)

Correspondence Address: Coherent, Inc. c/o Morrison & Forester, 425 Market Street, San Francisco, CA, 94105-2482, US

(21) Appl. No.: 12/221,219

(22) Filed: Jul. 31, 2008

(51) Int. Cl. H01S 3/10

(52) U.S. Cl. 372/22; 372/21

(57) ABSTRACT

A traveling wave ring-resonator is configured to deliver CW single-longitudinal-mode radiation having a fundamental wavelength characteristic of an optically pumped gain-element in the resonator. The delivered fundamental-wavelength radiation is the output-radiation of the resonator. An optically nonlinear crystal is located in the resonator and arranged to convert a fraction of fundamental-wavelength radiation into second harmonic radiation. The conversion of this fraction of fundamental-wavelength radiation to second-harmonic radiation minimizes mode-hopping in the output radiation.

### TECHNICAL FIELD OF THE INVENTION

The present invention relates in general to solid state lasers. The invention relates in particular to solid-state lasers arranged to operate in a single longitudinal mode.

### DISCUSSION OF BACKGROUND ART

A laser having a laser resonator that operates in a single longitudinal mode is preferred in applications where low bandwidth, high temporal coherence, and low noise are required. Such applications include high-resolution spectroscopy, optical parametric oscillator OPO pumping, and interferometry, among others. In a relatively long resonator for example a resonator having a length of about 1.0 meters, there are approximately 885 possible longitudinal modes of oscillation per nanometer of wavelength at 1064 nm, spaced equally in frequency. The resonator can be regarded as a very thick etalon with the possible modes being equivalent to transmission wavelengths of that etalon and the frequency spacing of adjacent modes being equal to the free spectral range of that etalon.

Many of the theoretically possible modes will usually fall within the gain-bandwidth of a solid-state gain-medium located in the resonator. By way of example, in a ring resonator having a neodymium-doped yttrium vanadate (Nd:YVO₄) gain-medium and length of 1.0 meters, about 800 longitudinal modes will fall within the approximately 230 GHz gain-bandwidth of the gain medium. If the resonator is configured not to support lateral modes of oscillation, the resonator will prefer to lase on that longitudinal mode within the gain-bandwidth that experiences the highest gain. Provided that the laser resonator continues to lase exactly on that particular longitudinal mode the resonator output will be stable.

In practice, changes in the operating environment or parameters of the resonator, particularly changes in temperature, will cause changes in the effective optical length of the resonator. This can involve temperature-induced changes in the axial physical separation of resonator mirrors, or temperature-induced changes in refractive index or length in the gain-medium or in any other transmissive optical components in the resonator.

A relatively small change in the effective optical length of the resonator does not significantly change the frequency-spacing of adjacent longitudinal modes but does change the actual frequency of all possible modes. If the length changes sufficiently, the currently-lasing mode is no longer the mode experiencing highest gain, in which case the resonator will begin to lase on an adjacent mode that does experience the highest gain. This is termed “mode-hopping” by practitioners of the art.

However stably a resonator is operating before a mode-hop occurs, there is a period of unstable multi-mode operation that accompanies the mode hop. The total output power can fluctuate during this period. Even with all reasonable precautions being taken to stabilize the operating environment of the resonator such mode-hops can occur at irregular intervals of a few seconds or minutes, possibly at inconvenient moments. Recognizing that a laser manufacturer usually will have no control over the operating environment provided by of a user of that laser, there is need for a resonator configuration that is more resistant to mode-hopping than resonators of currently available lasers.

### SUMMARY OF THE INVENTION

The present invention is directed to minimizing mode-hopping in a CW single-longitudinal-mode laser. In one aspect, a laser in accordance with the present invention comprises a laser resonator configured for operation in a single longitudinal mode. At least one gain-element is located in the laser-resonator. An arrangement is provided for energizing the gain-element such that continuous-wave (CW) single-longitudinal-mode radiation circulates in the resonator, the circulating radiation having a fundamental wavelength within a gain-bandwidth of the gain-element. An optically nonlinear crystal is also located in the resonator. The resonator is further configured such that a fraction of the circulating CW single-longitudinal-mode radiation is delivered from the resonator as output radiation at the fundamental wavelength. A fraction of the circulating radiation in the resonator is converted by the optically non-linear crystal into second-harmonic radiation for minimizing mode-hopping in the CW single-longitudinal-mode output radiation of the resonator.

In a preferred embodiment of the laser the resonator is a traveling-wave ring-resonator. In one example of this preferred embodiment there are two gain-elements of Nd:YVO₄. The fundamental radiation has a wavelength of about 1064 nm. About 2% of the circulating fundamental radiation is converted to second-harmonic radiation. About 25 W of fundamental-wavelength radiation and 4 W of second-harmonic radiation (having a wavelength of 532 nm) are delivered from one resonator mirror. The second harmonic radiation is separated from the fundamental radiation and discarded.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates a preferred embodiment of a laser in accordance with the present invention including a traveling-wave ring laser-resonator having two solid-state gain elements therein, a diode-laser pumping-arrangement for optically pumping the gain-elements such that CW radiation having a fundamental wavelength characteristic of the gain-elements circulates in the resonator, and wherein the principle output of the resonator is CW single-mode fundamental radiation and the resonator includes an optically nonlinear crystal arranged to convert a fraction of the circulating fundamental radiation to second-harmonic radiation for minimizing mode-hopping in the fundamental output wavelength.

FIG. 2 is a graph schematically illustrating time between successive mode hops after the pump diodes are switched on for an example of the laser of FIG. 1 and for two control lasers similar to the laser of FIG. 1 but in which the optically nonlinear crystal is omitted.

FIG. 3 is a graph schematically illustrating lasing-mode frequency-change as a function of time in the example of the laser of FIG. 1.

### DETAILED DESCRIPTION OF THE INVENTION

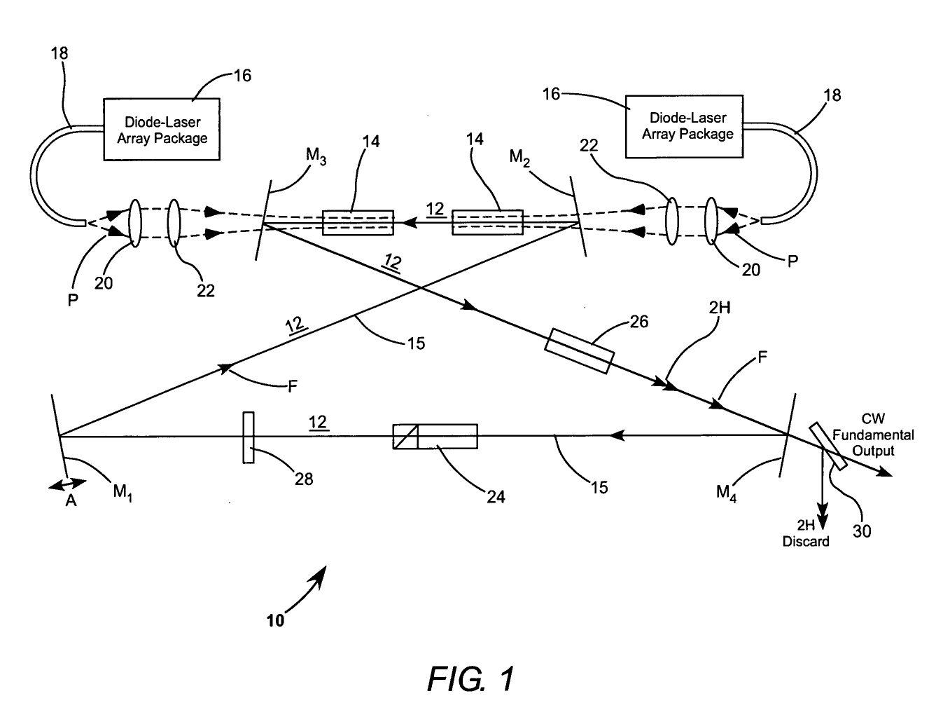

Referring now to the drawings, wherein like components are designated by like reference numerals, FIG. 1 schematically illustrates an intracavity-frequency-doubled ring-laser 10 including a preferred embodiment of the pumping method of the present invention. Laser 10 includes a ring resonator 12 in a configuration commonly referred to by practitioners of the art as a “bow-tie” configuration. Resonator 12 is formed by mirrors M₁, M₂, M₃, and M₄. Two solid state gain-elements 14, for example gain-elements of Nd:YVO₄, are included in the resonator between mirrors M₂ and M₃.

Each gain-element 14 is continuous-wave (CW) optically pumped by a beam of pump-light P from a corresponding diode-laser fiber-array package (diode-laser FAP) 16. The pump-light is delivered from each of the diode-laser FAPs via a fiber bundle or a multi-mode transport fiber 18. Light from the transport fiber is collimated by a lens 20 and focused by a lens 22 to a beam-waist in the corresponding gain-element 14. The wavelength of pump-light P is preferably selected to match the wavelength of an absorption peak of the gain-medium, for example the 808 nm peak of Nd:YVO₄.

As a result of optically pumping of the gain-medium, fundamental radiation F circulates in resonator 12 generally along a path 15 designated by a solid line in FIG. 1. An optical diode 24 located in the resonator provides that the radiation circulates in one direction only. An etalon 28 in the form of an uncoated plate of a relatively high index material that is transparent at the fundamental wavelength is configured to limit possible oscillating modes of the resonator by transmitting one mode with lower losses than modes adjacent thereto. The etalon can be thought of as shaping the gain-bandwidth profile of the gain-element.

A portion of circulating fundamental radiation is frequency-doubled by an optically non-linear crystal 26 to stabilize the single-longitudinal mode operation. This generates second-harmonic radiation 2H. Mirrors M₁, M₂, and M₃ are each highly reflective, for example greater than 99% reflective, for fundamental radiation F. Mirrors M₂ and M₃ are highly transmissive, for example greater than 95% transmissive, at the wavelength of pump-light P. Mirror M₄ is partially reflective and partially transmissive for fundamental radiation F and highly transmissive for the 2H-wavelength, for example greater than 99% transmissive. Mirror M₄ serves as an outcoupling mirror for the fundamental wavelength radiation of the resonator, which radiation is the intended CW output of laser 10.

This CW output is stabilized by the conversion of the portion of the circulating fundamental radiation into 2H-radiation in crystal 26. This 2H-radiation is conveniently extracted from the resonator via mirror M₄ as above-specified. The 2H-radiation is separated from the output fundamental radiation by one or more dichroic mirrors 30. Although only one is depicted in FIG. 1, preferably two are used. The separated 2H-radiation can be directed to a light absorbing beam-dump or allowed to dissipate via multiple reflections from the inside of an enclosure (not-shown) housing the laser components.

It is emphasized here that the output radiation of laser 10 is primarily fundamental radiation characteristic of gain-elements 14. The 2H-radiation is generated in resonator 12 to stabilize this output radiation by minimizing the occurrence of mode-hopping. Thus, it is intended that the power of the fundamental radiation coupled out of the resonator is greater than the 2H-radiation coupled out of the resonator and preferably at least two to five times greater.

As can be appreciated, it is preferable to convert only as much of the circulating fundamental radiation to 2H-radiation as is necessary to achieve this stabilization, as converting more than this will reduce the fundamental output power. It is believed that converting as little as 1% of the circulating fundamental radiation can provide a significant increase in stability and that converting more than about 10% of the fundamental radiation will not necessarily provide greater stability. It is emphasized here that these percentages are appropriate for Nd:YVO4 but may be somewhat different for a different gain-material.

It has been found that with laser 10 stabilized as described above the optical path length (length of path 15) in resonator 12 can be changed sufficiently to tune a single longitudinal mode through a portion of the gain-bandwidth (multiples of the longitudinal mode spacing) of a Nd:YVO₄ gain element without a mode-hop occurring in the process. The change in path-length required is sufficiently small that the change can be accomplished by selectively moving a resonator mirror normal (perpendicular) to the reflective surface thereof by a few microns, for example by moving mirror M₁ as indicated in FIG. 1 by arrows A. This movement can readily be accomplished by a piezoelectric actuator or a peristaltic actuator (not shown).

An experiment to quantify the stabilizing effect of partial 2H-conversion was conducted in an example of laser 10 wherein gain-elements 14 were Nd:YVO₄ gain elements. About 35.0 Watts (W) of pump radiation having a wavelength of about 808 nm was delivered to each gain-element. The fundamental radiation wavelength was about 1064 nm, with 2H-radiation correspondingly having a wavelength of about 532 nm. The longitudinal-mode spacing was about 400 MHz. This experimental laser was a Verdi™ model laser manufactured by Coherent Inc, of Santa Clara, Calif., the assignee of the present invention. Verdi™ laser is an intracavity-frequency-doubled laser that delivers CW single-mode radiation at a wavelength of 532 nm. This laser includes a traveling-wave ring-resonator having a configuration similar to that schematically depicted in FIG. 1.

The Verdi™ laser was modified by replacing original mirror M₄ with a mirror M₄ as specified above for coupling out both 1064 nm output radiation and 532 nm radiation from the second-harmonic conversion. The mirror was 85% reflective and 15% transmissive for the fundamental (1064 nm) radiation and more than 99% transmissive for the 2H (532 nm) radiation. Optically nonlinear crystal 26 was a lithium triborate (LBO) crystal enclosed in a thermal-control oven, the temperature of which was adjusted such that the second-harmonic-conversion was optimized for the crystal. About 2% of circulating fundamental radiation was converted to 2H-radiation such that the output from mirror M4 consisted of about 25.0 W of 1064 nm radiation and about 4.0 W of 532 nm radiation. In the prior-art Verdi laser in which only 532 nm radiation is delivered the second harmonic conversion efficiency of crystal 26 is about 6%

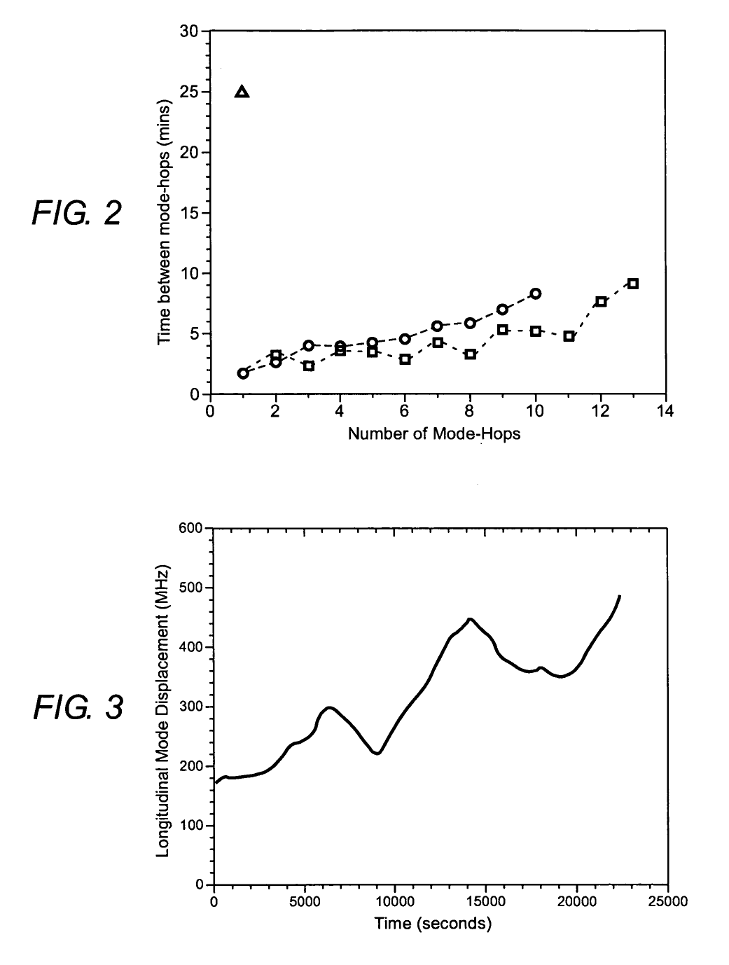

FIG. 2 is graph schematically illustrating time between successive mode-hops, recorded over a period of up to two hours, for the above discussed example of laser 10 (triangle point marker) and two examples of laser 10 (circular and square markers) without optically nonlinear crystal 26 in the resonator. In the example of the triangular marker and the circular markers, etalon 28 in resonator 12 was a YAG etalon having a free spectral range of 75.0 gigahertz (GHz). In the example of the square markers, etalon 28 was a sapphire (Al₂O₃) etalon having a free spectral range of 50.0 GHz. In the lasers without crystal 26 in the resonator there was no indication that the lasers would stabilize over time such that no mode-hopping would occur. In the inventive example including the optically nonlinear crystal only one mode-hop occurred about 25 minutes after starting the laser.

FIG. 3 graphically illustrates results of another experiment in which longitudinal-mode frequency was tracked continuously over a period of about six hours. During this period the actual frequency of the single longitudinal lasing mode drifted, but without discontinuity over a range of 300 MHz as indicated in the graph. The absence of any discontinuity in the curve indicates that no mode-hop occurred during the observation period.

The results discussed above indicated that mode-hopping in the inventive laser can be essentially eliminated by converting about 2% of circulating fundamental radiation into second harmonic radiation. While this conversion reduces the available fundamental radiation output-power this reduction is less than about 14% which would likely be tolerable in any application in which high output stability is important.

While the present invention is described above with reference to an example in which 1064 nm radiation is delivered from the resonator the present invention is not limited to use at any particular wavelength. Correspondingly, the invention is not limited to use with any number of gain-elements or to a gain-element of any particular material. Further the, invention is not limited to any particular method of optically pumping a gain-element.

It should also be noted that while the second-harmonic radiation generated by the optically nonlinear crystal is extracted from the resonator of FIG. 1 via the same mirror through which output fundamental radiation is delivered this should also not be construed as limiting the present invention. The second-harmonic radiation could be extracted through a different resonator mirror or by a separate dichroic mirror located in an arm of the resonator. As the fundamental and 2H radiations have polarization orientations at 90 to each it would be possible to use a polarizing beam-splitter to extract 2H radiation.

It should further be noted that while the present invention has been described in the context of a traveling-wave ring resonator, principles of the invention are applicable in a linear, standing-wave resonator, including a resonator in which the gain-element is a thin disc of a doped crystalline material, or a surface-emitting semiconductor gain-structure located at one end of the resonator.

In summary, the present invention is described above in terms of a preferred embodiment. The invention is not limited, however, to the embodiment described and depicted. Rather, the invention is limited only by the claims appended hereto.

What is claimed is:

1. A laser comprising:
a laser resonator configured for operation in a single longitudinal mode;
at least a first gain-element located in the laser-resonator;
an arrangement for energizing the gain-element such that continuous-wave (CW) single-longitudinal-mode radiation circulates in the resonator, the circulating radiation having a fundamental wavelength within a gain-bandwidth of the gain-element;
an optically nonlinear crystal located in the resonator;
the resonator being further configured such that a fraction of the circulating CW single-longitudinal-mode radiation is delivered from the resonator as output radiation; and
wherein a fraction of the circulating radiation in the resonator is converted by the optically nonlinear crystal into second-harmonic radiation for minimizing mode-hopping in the CW single-longitudinal-mode output radiation of the resonator and wherein a portion of the second harmonic radiation is delivered from the resonator as output radiation and wherein the power of the single longitudinal mode radiation delivered from the resonator is greater than the power of the second harmonic radiation delivered from the resonator.

2. The laser of claim 1, wherein the laser resonator is a traveling-wave ring resonator.

3. The laser of claim 1, wherein between about 1% and 10% of the circulating fundamental radiation is converted into second-harmonic radiation.

4. The laser of claim 1, wherein about 2% of the circulating fundamental radiation is converted into second-harmonic radiation and 15% of the circulating fundamental radiation delivered from the resonator as the output radiation.

5. The laser of claim 1, wherein the second harmonic radiation and the fundamental-wavelength output radiation are delivered from the resonator via one mirror of the resonator.

6. The laser of claim 1, wherein the optical length of the resonator is selectively adjustable for selectively adjusting the wavelength of the circulating fundamental radiation within the gain-bandwidth of the gain-element.

7. The laser of claim 1, wherein there are first and second gain-elements in the resonator and the gain-elements are energized by radiation from respectively first and second diode-laser arrays.

8. A laser comprising:
a traveling-wave laser resonator configured for operation in a single longitudinal mode;
at least a first gain-element located in the laser-resonator;
an arrangement for energizing the gain-element such that continuous-wave (CW) single-longitudinal-mode radiation circulates in the resonator, the circulating radiation having a fundamental wavelength within a gain-bandwidth of the gain-element;
an optically nonlinear crystal located in the resonator;
the resonator being further configured such that a fraction of the circulating CW single-longitudinal-mode radiation is delivered from the resonator as output radiation; and
wherein a fraction of the circulating radiation in the resonator is converted by the optically nonlinear crystal into second-harmonic radiation for minimizing mode-hopping in the CW single-longitudinal-mode output radiation of the resonator wherein a portion of the second harmonic radiation is delivered from the resonator as output radiation and wherein the power of the single longitudinal mode radiation delivered from the resonator is greater than the power of the second harmonic radiation delivered from the resonator.

9. The laser of claim 8, wherein between about 1% and 10% of the circulating fundamental radiation is converted into second-harmonic radiation.

10. The laser of claim 8, wherein about 2% of the circulating fundamental radiation is converted into second-harmonic radiation and 15% of the circulating fundamental radiation delivered from the resonator as the output radiation.

11. The laser of claim 8, wherein the second-harmonic radiation and the fundamental-wavelength output radiation are delivered from the resonator via one mirror of the resonator.

12. The laser of claim 8, wherein the optical length of the resonator is selectively adjustable for selectively adjusting the wavelength of the circulating fundamental radiation within the gain-bandwidth of the gain-element.

13. The laser of claim 8, wherein the traveling-wave resonator is formed by first, second, third, and fourth mirrors and the resonator is in a bow-tie configuration.

14. The laser of claim 13, wherein there are first and second gain-elements in the resonator and the gain-elements are energized by radiation from respectively first and second diode-laser arrays.

15. The laser of claim 14, wherein the first and second gain-elements are located between the second and third mirrors, the optically nonlinear crystal is located between the third and fourth mirrors, and wherein CW single-longitudinal-mode output-radiation and the second-harmonic radiation are delivered from the resonator via the fourth mirror.

16. The laser of claim 15, wherein the fourth mirror is movable in a direction perpendicular to a reflective surface thereof for selectively adjusting the optical length of the resonator and thereby selectively adjusting the wavelength of the circulating fundamental radiation within the gain-bandwidth of the gain-element.

17. A method of operating a laser in a manner to suppress mode hopping, said laser including a gain medium located within a resonator, said method comprising the steps of:
optically pumping the gain medium to generate CW radiation at a fundamental wavelength;
using a non-linear crystal, converting a fraction of the fundamental radiation into higher harmonic radiation; and
coupling both the fundamental and the higher harmonic radiation out of the resonator wherein the power of the fundamental radiation coupled out of the resonator is at least twice as great as the power of the higher harmonic radiation coupled out of the resonator.

18. A method as recited in claim 17, wherein the non-linear crystal is arranged to convert about two percent or less of the fundamental radiation into higher harmonic radiation.

19. A method as recited in claim 17, wherein the resonator is a ring resonator and wherein the radiation circulates in a unidirectional manner.

20. A method as recited in claim 17, further including the step of adjusting the wavelength of the fundamental radiation by adjusting a mirror of the resonator.
